(19) United States
(12) Patent Application Publication
(10) Pub. No.: US 2008/0131772 A1
(43) Pub. Date: Jun. 5, 2008

(54) ELECTROLYTES, ELECTROLYTE ADDITIVES AND CELLS

(75) Inventors: Krishnakumar Jambunathan, Macungie, PA (US); Gennady Dantsin, Allentown, PA (US); William Jack Casteel, Fountain Hill, PA (US); Sergei Vladimirovich Ivanov, Schnecksville, PA (US); Zhong Shi, Allentown, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: AIR PRODUCTS AND CHEMICALS, INC., Allentown, PA (US)

(21) Appl. No.: 12/031,256

(22) Filed: Feb. 14, 2008

Related U.S. Application Data
(63) Continuation-in-part of application No. 11/300,287, filed on Dec. 15, 2005.
(60) Provisional application No. 60/642,815, filed on Jan. 11, 2005.

(51) Int. Cl. H01M 10/40

(52) U.S. Cl. 429/199; 429/206; 429/207

(57) ABSTRACT

An electrolyte comprising a salt, which will not electrochemically passivate and at least two additives. A cell comprising a positive electrode, a negative electrode and an electrolyte comprising a salt, which will not electrochemically passivate and at least two additives.

### CROSS REFERENCE TO RELATED PATENTS AND PATENT APPLICATIONS

The instant invention is related to U.S. patent application Ser. Nos. 10/655,476, filed Sep. 4, 2003; 10/910,529, filed Aug. 3, 2004; 10/924,293, filed Aug. 23, 2004; 11/097,810, filed Apr. 1, 2005; 11/843,889, filed on Aug. 23, 2007 and U.S. Pat. No. 6,781,005.

The disclosure of the previously identified patents and patent application is hereby incorporated by reference.

This application is a continuation-in-part of U.S. application Ser. No. 11/300,287, filed on Dec. 15, 2005. The disclosure of the parent application is hereby incorporated by reference. This application claims the benefit of Provisional Application No. 60/642,815, filed Jan. 11, 2005. The disclosure of this Provisional Application is hereby incorporated by reference.

### BACKGROUND OF THE INVENTION

Lithium secondary batteries, by virtue of the large reduction potential and low molecular weight of elemental lithium, offer a dramatic improvement in power density over existing primary and secondary battery technologies. Lithium secondary batteries are batteries containing metallic lithium as the negative electrode and batteries which contain a lithium ion host material as the negative electrode, also known as lithium-ion batteries. By secondary battery it is meant a battery that provides for multiple cycles of charging and discharging. The small size and high mobility of lithium cations allow for the possibility of rapid recharging. These advantages make lithium ion batteries ideal for portable electronic devices, e.g., cell phones and laptop computers. Recently, larger size lithium ion batteries have been developed and have application for use in the hybrid vehicle market.

The following patents are representative of lithium batteries and electrochemical cells:

U.S. Pat. No. 4,201,839 discloses electrochemical cells based upon alkali metal-containing anodes, solid cathodes, and electrolytes where the electrolytes are closoborane compounds carried in aprotic solvents. Closoboranes employed are of the formula Z₂BnXn and ZCRBmXm wherein Z is an alkali metal, C is carbon, R is a radical selected from the group consisting of organic hydrogen and halogen atoms, B is boron, X is one or more substituents from the group consisting of hydrogen and the halogens, m is an integer from 5 to 11, and n is an integer from 6-12. Specifically disclosed examples of closoborane electrolytes employed in the electrochemical cells include lithium bromooctaborate, lithium chlorodecaborate, lithium chlorododecabate, and lithium iododecaborate.

U.S. Pat. No. 5,849,432 discloses electrolyte solvents for use in liquid or rubbery polymer electrolyte solutions based upon boron compounds with Lewis acid characteristics, e.g., boron linked to oxygen, halogen atoms, and sulfur. A specific example of an electrolyte solution comprises lithium perchlororate and boron ethylene carbonate.

U.S. Pat. No. 6,346,351 discloses secondary electrolyte systems for a rechargeable battery of high compatibility towards positive electrode structures based upon a salt and solvent mixture. Lithium tetrafluoroborate and lithium hexafluorophosphate are examples of salts. Examples of solvents include diethyl carbonate, dimethoxyethane, methylformate, and so forth. In the background, there are disclosed known electrolytes for lithium batteries, which include lithium perchlorate, lithium hexafluoroarsenate, lithium trifluoromethylsulfonate, lithium tetrafluoroborate, lithium bromide, and lithium hexafluoroantimonate electrolytes incorporated in solvents.

U.S. Pat. No. 6,159,640 discloses electrolyte systems for lithium batteries used in electronic equipment such as mobile phones, laptop computers, camcorders, etc based upon fluorinated carbamates. A variety of fluorinated carbamate salts, e.g., trifluoroethyl-N,N-dimethylcarbamate is suggested.

U.S. Pat. No. 6,537,697 discloses a lithium secondary battery using a nonaqueous electrolyte including lithium tetrakis(pentafluorophenyl)borate as an electrolyte salt.

(D. Aurbach, A. Zaban, Y. Ein-Eli, I. Weissman, O. Chusid, B. Markovsky, M. Levi, E. Levi, A. Schechter, E. Granot) and (S. Mori, H. Asahina, H. Suzuki, A. Yonei, K. Yokoto) describe the phenomenon of anode passivation by electrolyte reduction in lithium metal and lithium ion batteries using a carbon host anode material, and its cause of irreversible capacity loss at the graphite anode in lithium ion battery applications. In general, for graphitic carbons some reduction of both solvent and salt occurs at the graphite surface at low potentials during charging of the cell. This forms a electrode/electrolyte interface layer, sometimes referred to as a solid electrolyte interface (SEI) layer, which in some cases is stable and prevents further capacity loss and in other cases is unstable. The layer is comprised of solvent and salt decomposition products. Use of ethylene carbonate as one of the cosolvents leads to stable passivation layers, while using high levels of propylene carbonate in the absence of ethylene carbonate leads to significant irreversible capacity loss due to exfoliation of the graphite.

U.S. Pat. No. 5,626,981 describes the use of a small amount of vinylene carbonate to improve the passivation layer formed by ethylene carbonate (EC) and EC/propylene carbonate (PC) based solvents with standard electrolyte salts. The final reversible capacity is improved slightly with this additive.

U.S. Pat. No. 6,924,066 describes an electrolyte containing a lithium containing inorganic salt, such as LiPF₆ as the main conducting salts and a lithium borate salt such as a chelato-borate, including lithium bis-oxalatoborate as an additive salt to aid in cell passivation.

U.S. Pat. No. 5,571,635 discloses that high reversible capacity over multiple charge/discharge cycles is not obtainable in solvent systems which are predominantly propylene carbonate. Propylene carbonate, which is a desirable solvent because of its wide liquid range and high dielectric constant, gives continuous capacity fade by virtue of cointercalation/exfoliation reactions. This patent describes the use of chloroethylene carbonate as a cosolvent with propylene carbonate, which acts to form stable passivation films on crystalline graphites when used with standard electrolyte salts, such as LiPF₆, LiBF₄, lithium bis-oxalatoborate (LiBOB), LiCF₃SO₃, etc. It describes the use of chloroethylene carbonate as an additive for reducing irreversible capacity loss with ethylene carbonate/propylene carbonate solvent mixtures.

The disclosure of the previously identified patents and publications is hereby incorporated by reference.

A key challenge to the reversibility of cells has been their reactivity toward the electrolyte solution components (salt and solvent) under the charging conditions. Heretofore, it has been observed that all electrolyte salts and solvents undergo some reduction at the negative electrode during at least the initial charging step. This reduction can either lead to a stable, conducting passivation layer or film also referred to as a Solid Electrolyte Interface or SEI layer, or reduction can continue with charge/discharge cycling eventually leaving no reversible capacity in the negative electrode.

### BRIEF SUMMARY OF THE INVENTION

The present invention solves problems associated with conventional electrolytes and cells by providing an electrolyte and a cell having improved leakage current characteristics, increased charge capacity retention, among other desirable properties. The present invention relates to electrolytes comprising novel salts and additives and to cells employing such electrolytes.

In one aspect, the present invention provides an electrolyte having a second cycle reduction current in Cyclic Voltammetry (CV) measurements that is less than that of the first cycle, said electrolyte comprising at least one salt that will not provide any substantial electrochemically passivation (to the electrode). The CV measurements were performed on the electrolyte system in a three electrode setup (Electrochemical Methods, Allen J. Bard and Larry R. Faulkner; John Wiley & Sons, 1980 p. 213; hereby incorporated by reference). The working electrode can be a Pt or glassy carbon, the counter electrode is usually lithium foil and the reference electrode is lithium foil and is referenced as Li/Li⁺.

In another aspect, this invention provides an electrolyte as described above further comprising an additive or several additives. In one aspect of the invention, the additive comprises at least two compounds wherein at least one of the two compounds comprises an inorganic compound. The second compound can comprise at least one suitable organic compound.

In a further aspect, the invention provides a cell (e.g, a secondary battery), comprising a positive electrode, a negative electrode and an electrolyte, said electrolyte having a second cycle reduction current in cyclic voltammetry measurements that is less than that of the first cycle, said electrolyte comprising a salt, which is not reduced in the cell environment.

This invention further provides electrolytes or cells as described above further comprising lithium.

This invention further provides electrolytes or cells comprising lithium of the formula:

LiₐQ

where Q comprises a monovalent or divalent borate or heteroborate cluster anion, a may be 1 or 2.

### BRIEF DESCRIPTION OF THE DRAWINGS

FIG. 1 shows the cell capacity (Ah) vs the cycle number for an electrolyte (and cell) of this invention vs a comparative electrolyte (and cell).

FIG. 2 shows the cell capacity (Ah) vs the cycle number for electrolytes (and cells) of this invention made by the method of Examples 17-22 vs a comparative electrolyte (and cell) made by a comparative method.

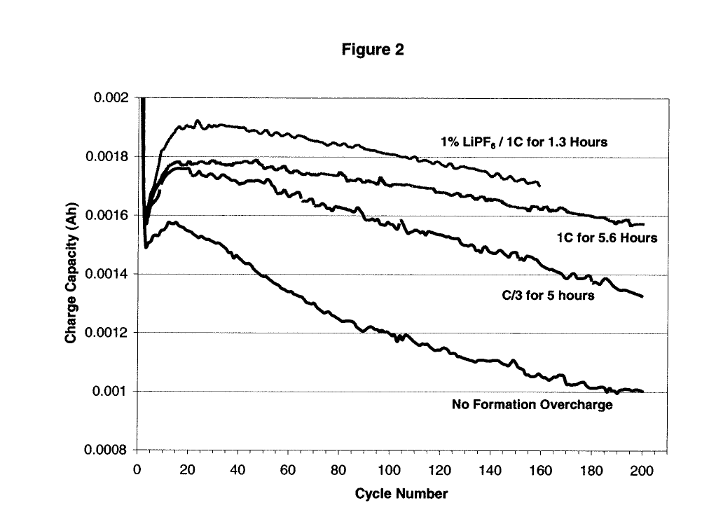

FIG. 3 shows the cell capacity (Ah) vs the cycle number for electrolytes (and cells) of this invention made by the method of Examples 23-24 vs a comparative electrolyte (and cell) made by a comparative method.

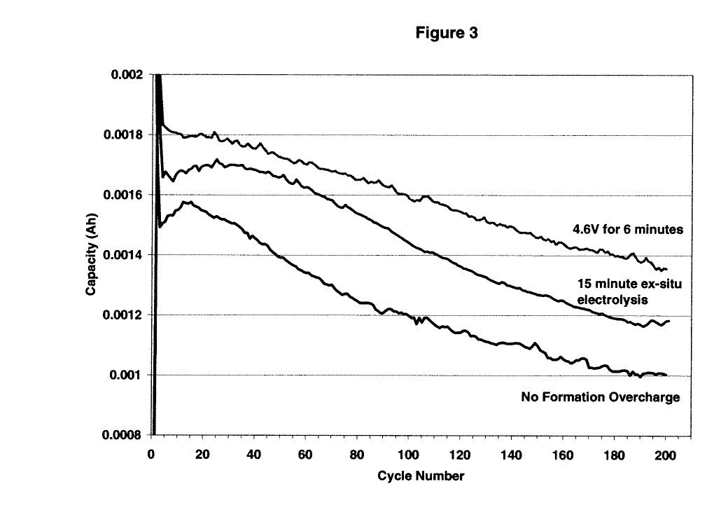

### DETAILED DESCRIPTION OF THE INVENTION

A high voltage secondary battery cell comprising a battery having a full charge potential typically greater than 2 V and capable of multiple cycles of charging and discharging, is dependent on an electrolyte carrying ions. The term electrolyte alone will refer to an electrolyte salt, electrolyte salt in a solvent or an electrolyte salt in a polymer or gel. Electrolyte salts and solutions for such cells should provide: (a) a high conductivity in a non-aqueous ionizing solution, (b) chemical stability to heat, e.g. cell temperatures of >50° C., typically >80° C. and in some cases >100° C., stability toward hydrolysis and/or HF generation in the presence of water or alcohols, and electrochemical cycling over a wide potential range, e.g., 3 to 3.6V, typically 3 to 4.2 V and in some cases 3 to >4.2V and/or (c) an ability of the electrolyte and/or additives therein to form a stable, passivating ion conducting interfacial or SEI layer at the electrode/electrolyte interface.

A battery may comprise one or more electrochemical cells; however the terms battery and cell may be used interchangeably herein to mean a cell. Any reference to a voltage herein refers to voltage versus the lithium/lithium⁺ (Li/Li⁺) couple.

The electrolyte of this invention comprises a salt that is not reduced and/or will not provide electrochemical passivation (passivation is achieved in the instant invention by the employing the compositions and methods described herein). Electrochemical passivation is a process which results in the formation of a film on the electrode surface, and thus reduces the reduction current in the second CV cycle compared to the reduction current of the first CV cycle. If passivation does not occur then the second CV cycle will be the same or higher than the first CV cycle.

The salt can be any salt or mixture of salts. In one embodiment, the salt comprises lithium. In another embodiment, the salt comprises a lithium salt of the formula:

LiₐQ

where Q comprises a monovalent or divalent borate or heteroborate cluster anion, and a is 1 or 2. The group Q comprises at least one member selected from the following borate (i) and heteroborate (ii and iii) anions:
i) The closo-borate anion compositions of formula (BₙZₙ)²⁻, where Z comprises F, H, Cl, Br, and/or (OR), where R comprises H, C₁₋₈, such as C₁₋₃ alkyl or fluoroalkyl, and n is 8 to 12. The compositions are polyhedral clusters consisting of eight to twelve boron atoms where each boron is attached as defined to a hydrogen, a halogen atom or hydroxyl group.
ii) The closo-ammonioborate anion compositions of formula:

((R′R″R′″)NBₙZₙ₋₁₎¹⁻;
where N is bonded to B and each of R′, R″, and R′″ is independently selected from the group consisting of hydrogen, alkyl, aryl and/or a polymer, Z comprises F, H, Cl, Br, and/or (OR), where R comprises H, alkyl, fluoroalkyl or aryl; and n is 8 to 12. These anion compositions are also polyhedral boron clusters of 8 to 12 boron atoms, where one of the boron atoms is attached to an ammonia group (NR′R″ R′″), with F, H, Cl, Br and OR groups attached to the remaining boron atoms. A description of these compositions may be found in U.S. Pat. No. 6,335,466 B1; incorporated herein by reference. The alkyl, and fluoroalkyl groups may be branched, cyclic or straight-chained groups having 1 to 20 carbon atoms, and if fluorinated may have 1 to 42 fluorine atoms. The term aryl refers to aromatic ring systems, usually containing 5 to 20 ring atoms. Polymers can comprise at least one member selected from the group consisting of polystyrene, polyethylene, polyethylene glycol, among others, which allow the anions to be bound to a polymeric support.
iii) The closo-monocarborate anion compositions of formula: (R″″CBₙZₙ)¹⁻, where R″″ is bonded to C and selected from the group consisting of hydrogen, alkyl, cycloalkyl, aryl, and a polymer; Z comprises F, H, Cl, Br, and/or (OR), where R comprises H, alkyl or fluoroalkyl; and n is 7 to 11. These fluorinated closo-monocarborate anion compositions are also polyhedral clusters that comprise 7-11 boron atoms and a single carbon atom. Such anion compositions are described in U.S. Pat. No. 6,130,357; incorporated herein by reference. The alkyl, and fluoroalkyl groups may comprise branched, cyclic or straight-chained groups having 1 to 20 carbon atoms, and if fluorinated will have 1 to 42 fluorine atoms. The term aryl refers to aromatic ring systems, typically containing 5 to 20 ring atoms. Polymers comprise at least one member selected from the group consisting of polystyrene, polyethylene, polyethylene glycol, among others, which allow the anions to be bound to a polymeric support.

Examples of lithium salts that can comprise the electrolyte salt of this invention are lithium fluoroborates represented by the formulas:

Li₂B₁₀FₓZ₁₀₋ₓ

and

Li₂B₁₂FₓZ₁₂₋ₓ

wherein x is at least 1, or at least 3 for the decaborate salt, or at least 5, or at least 8, for the dodecaborate salts. Z represents H, Cl, Br, or OR, where R═H, C₁₋₈, typically C₁₋₃ alkyl or fluoroalkyl. Useful compounds are Li₂B₁₂F₁₂, and mixtures of Li₂B₁₂FₓZ₁₂₋ₓ where x is 6, 7, 8, 9, 10, 11 and 12.

Specific examples of lithium fluoroborate compounds comprise at least one member selected from the group consisting of Li₂B₁₂F₈₋₁₂Z₀₋₄ where Z comprises Cl, Br, or OR where R comprises C₁₋₈, usually C₁₋₃. Typically, the salts comprise at least one member selected from the group consisting of Li₂B₁₀F₁₀, Li₂B₁₂F₁₂, Li₂B₁₂F₁₀₋₁₂(OH)₀₋₂, Li₂B₁₂F₁₀₋₁₂(Cl)₂, Li₂B₁₂F₈₋₁₀(H)₀₋₂, Li₂B₁₂F₈₋₁₂(OCF₃)₀₋₄, and Li₂B₁₀F₈₋₁₀Br₀₋₂.

The electrolyte further comprises a solvent or carrier, referred to collectively as solvent, to provide an electrolyte solution. The solvent or carrier may be an aprotic solvent. Typically, these aprotic solvents are anhydrous, forming anhydrous electrolyte solutions. By “anhydrous” it is meant that the solvent or carrier as well as the electrolyte comprises less than about 1,000 ppm water and normally less than about 500 to 100 ppm. Examples of aprotic solvents or carriers for forming the electrolyte solutions comprise at least one member selected from the group consisting of organic aprotic carriers or solvents, organic carbonates esters or ethers, their fluorinated derivatives, mixtures thereof, among others. These include ethylene carbonate (EC), propylene carbonate (PC), fluoroethylene carbonate (FEC), difluoroethylene carbonate (DFEC), dimethyl carbonate (DMC), ethyl methyl carbonate (EMC), diethyl carbonate (DEC), methyl propyl carbonate (MPC), ethyl propyl carbonate (EPC), dipropyl carbonate (DPC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, vinylene carbonate (VC), vinylethylenecarbonate (VEC); among other carbonates, fluorinated oligomers, dimethoxyethane, triglyme, tetraethyleneglycol, dimethyl ether (DME), polyethylene glycols, sulfones, and gamma-butyrolactone (GBL). The solvent or carrier can also comprise at least one ionic liquid. By ionic liquid it is meant any room temperature molten salt. Examples of suitable ionic liquids comprise at least one member selected from the group consisting of asymmetric tetraalkyl ammonium salts of weakly coordinating anions such as butyl-trimethylammonium tetrafluoroborate, hexyl-trimethylammonium trifluoromethanesulfonimide, N-alkylpiperidium salts of weakly coordinating anions including N-methyl piperidinium tetrafluoroborate, N-ethylpiperidinium trifluoromethane sulfonate, N-butyl piperidinium trifluoromethanesulfonimide, among others which do not contain active or reducible hydrogens in the cation of the liquid.

In another embodiment, the electrolyte of the present invention can comprise an aprotic gel polymer carrier/solvent. Suitable gel polymer carrier/solvents can comprise at least one member selected from the group consisting of polyethers, polyethylene oxides, polyimides, polyphosphazines, polyacrylonitriles, polysiloxanes, polyether grafted polysiloxanes, derivatives of the foregoing, copolymers of the foregoing, crosslinked and network structures of the foregoing, blends of the foregoing, among others, to which is added an appropriate ionic electrolyte salt. Other gel-polymer carrier/solvents can comprise those prepared from polymer matrices derived from at least one member selected from the group consisting of polypropylene oxides, polysiloxanes, sulfonated polyimides, perfluorinated membranes (Nafion™ resins), divinyl polyethylene glycols, polyethylene glycol-bis-(methyl acrylates), polyethylene glycol-bis(methyl methacrylates), derivatives of the foregoing, copolymers of the foregoing, crosslinked and network structures of the foregoing. The aprotic gel polymer carrier may contain any of the aprotic liquid carriers described in the preceding paragraph.

If the electrolyte comprises the electrolyte salt in a solution, typically the concentration of salt will be from about 0.05 to about 2 molar or from about 0.1 to about 1.2 molar, or from about 0.2 to about 0.5 molar. Higher concentrations tend to become too viscous and, the bulk conductivity characteristics of a cell using the electrolyte may be adversely affected.

The chemical stability of the salts in the electrolytes of this invention, for example, Li₂B₁₂F₁₂ and Li₂B₁₂F₉H₃, makes them desirable as electrolyte salts for battery applications may prevent their participation in reductive passivation chemistry. When standard formation charging cycle(s) are used, a stable passivation film is not formed by the salts or solutions of these salts (e.g., such as described in U.S. Pat. No. 6,346,351, hereby incorporated by reference). Formation cycle(s) are the initial charge/discharge cycle or cycles of an assembled cell designed to form the SEI layer, and otherwise conditioning the cell for use. Typically, the charge/discharge formation cycle(s) is (are) performed at a slower rate than the charge/discharge rate under the normal operating conditions of the cell. The optimum conditions of the formation cycle can be determined experimentally for each electrolyte and battery. An example of a suitable formation cycle is described in U.S. Pat. No. 6,200,356 B1; hereby incorporated by reference. Another example of a suitable formation cycle is described in “The effect of the charging protocol on the cycle life of a Li-ion battery” by Zhang et al., Journal of Power Sources, 161 (2006) 1385-1391. The term formation cycle will be used herein to mean either one or more than one charge/discharge cycle to form the SEI layer. Without a stable SEI layer, the cell undergoes continual capacity fade on charging and discharging. In cyclic voltammetry (CV) experiments on these electrolytes of this invention using either glassy carbon or highly oriented pyrolytic graphite (HOPG) working electrodes relatively large reduction currents are observed on cycling the solution. Similarly large currents are observed on subsequent cycles. We have observed that any electrolytes, which give rise to this type of CV behavior typically afford relatively poor charge/discharge stability in batteries. Conversely, we have found that if electrolytes provide a CV behavior in which the second cycle reduction current observed is lower than the first, the charge/discharge cycle life of cells can be improved.

In one aspect of this invention, a passivation additive or combination of additives (also referred to herein as an additive/additives), is added to the electrolyte and the second cycle reduction current observed is lower than the first. In some aspects the ratio of the second cycle reduction current to that of the first cycle is less than or equal to about 0.88, or less than or equal to about 0.80 of the reduction current of the first cycle. Generally, the lower the reduction current, the better the corresponding performance. In some embodiments, a modification to the formation cycle also caused a change in the CV behavior such that the second cycle reduction current (e.g., observed at 0.3 V vs Li/Li⁺), is lower than the first cycle reduction current.

In one aspect of this invention, the electrolyte further comprises at least one and typically at least two additives to aid in passivation of the positive and negative electrodes. The additive (or combination of additives) can function to form a stable passivation layer. We have determined that an additive/s, which provides a cyclic voltammagram vs Li/Li⁺ in which the second cycle reduction current at 0.3 V is less than the first, will form a more stable SEI layer than the electrolyte of this invention, without an additive or additives. The electrolytes of this invention may provide better rate and thermal stability performance than electrolytes without this passivation. The passivation layer may contain reduction products of the solvent, and/or additive/s, and/or electrolyte salt. The additives will typically be organic material, inorganic salts or mixtures thereof.

In another aspect of the invention, the electrolyte comprises at least two additives wherein at least one of the additives comprises an inorganic compound. The second additive can comprise at least one organic and/or inorganic compound.

Additives that are organic compounds that can function to form the passivation layers can comprise at least one member selected from the group consisting of chloroethylene carbonate, vinylene carbonate (VC), vinylethylenecarbonate (VEC), and non-carbonate species such as ethylene sulfite, propane sulfone, propylene sulfite, as well as substituted carbonates, sulfites and butyrolactones, such as phenylethylene carbonate, phenylvinylene carbonate, catechol carbonate, vinyl acetate, vinylethylene carbonate, dimethyl sulfite, fluoroethylene carbonate, trifluoropropylene carbonate, bromo gamma-butyrolactone, fluoro gamma-butyrolactone, among others which provide organic salts on reduction at the at least one electrode, particularly the negative electrode.

Additives that are inorganic compounds or salts that may be useful in this invention can comprise at least one compound containing boron, nitrogen, phosphorous, arsenic, antimony, oxygen, sulfur, fluorine or chlorine, among others. Additives that are useful in this embodiment of the invention can comprise at least one member or a combination of additives selected from the group consisting of lithium hexafluorophosphate (LiPF₆), lithium bis-oxalatoborate (LiBOB) as described in U.S. Pat. No. 6,924,066 B2 (hereby incorporated by reference), and other chelato-borate salts (e.g., Li difluorooxalatoborate, LiBF₂(C₂O₄), Li(C₂O₃CF₃)₂, LiBF₂(C₂O₃CF₃), and LiB(C₃H₂O₃(CF₃)₂)₂ as described in U.S. Pat. No. 6,407,232, EP 139532B1 and JP2005032716 A; hereby incorporated by reference), lithium perchlorate (LiClO₄), lithium hexafluoroarsenate (LiAsF₆), lithium trifluoromethanesulfonate (LiCF₃SO₃), lithium trifluoromethanesulfonimide (Li(CF₃SO₂)₂N, lithium tetrafluoroborate (LiBF₄), lithium tetrachloroaluminate (LiClO₄), and lithium hexafluoroantimonate (LiSbF₆). Additional inorganic additives can comprise CO₂ which in a lithium-containing electrolyte forms Li₂CO₃ and SO₂, which can eventually forms Li₂S in the SEI layer. Similarly phosphate and borate esters as inorganic additives may be reduced to form lithium alkyl phosphate(borate) salts similar to those formed by LiPF₆ and LiBF₄, respectively. Without wishing to be bound by any theory or explanation, it is believed that the hydrolytic stability of the electrolyte salts, for example the borate cluster salts, even suggest that a small amount of water could be used as the passivating additive in electrolyte solutions; however, the H₂ generation may disrupt SEI layer formation.

For a lithium containing electrolyte, the passivation layer (SEI layer) formed by the additives listed herein may comprise lithium alkyl carbonates and Li₂CO₃ (from the electrolyte solvent/organic additive reduction), LiF (arising from hydrolyzable electrolyte salts such as LiPF₆, LiBF₄, LiAsF₆ and LiSbF₆), and salt reduction products, such as LiₓAsF_{y} (as a reduction product of LiAsF₆), LiₓPF_{y} (as a reduction product of LiPF₆), LiₓBF_{y} (as a reduction product of LiBF₄), LiBOₓR (as a reduction product of the bis-oxalatoborate or LiBOB salts), Li₂SO₃, Li₂S, and Li₂O (as reduction products of LiCF₃SO₃ and LiN(CF₃SO₂)₂) and LiCl and Li₂O (as reduction products of LiClO₄).

In one aspect of the invention, the additive comprises LiBF₄ and at least one member selected from the group consisting of at least one of the previously identified organic compounds and at least one of the previously identified inorganic compounds. For example, the member can comprises an organic compound such as VC. In another example, the member can comprise an inorganic compound such as LiBOB.

We have discovered that any additive or combination of additives, which provides a cyclic voltammagram of a borate cluster-based electrolyte vs Li/Li⁺ in which the second cycle reduction current is less than the first, will be effective. When such a combination of additives with stable electrolyte salts, further gives rise to lower self-discharge currents at elevated temperature storage, then stable, electrolyte salts, such as, lithium borate cluster salts can be used in batteries, with improved performance.

The additive or additives should be present in the electrolyte in an amount which forms an effective SEI layer. In some embodiments, a single additive may be present in an amount between about 0.1 and about 5% of the total weight of the electrolyte to be effective. In other aspects of the invention, two or more additives are present, each in an amount between about 0.1 and about 5% of the total weight of the electrolyte.

The battery or cell of this invention comprises any negative electrode and positive electrode, and the electrolyte of this invention. In one embodiment, the positive and negative electrodes of the battery are any using lithium containing materials, or materials that are capable of “hosting” ions in reduced or oxidized form, such as lithium. “Hosting” means that the material is capable of reversibly sequestering the ions, for example, lithium ions. The negative electrodes for the batteries of this invention can comprise at least one member selected from the group consisting of lithium metal or its alloys with other metals, carbonaceous materials, such as amorphous carbon or graphites (natural or artificial), tin, tin oxide, silicon, or germanium compounds and alloys thereof (e.g. tin cobalt alloys), metal oxides or derivatives of those materials (e.g., lithium titanate). The positive electrodes for use in batteries of this invention may be based upon a lithium composite oxide with a transition metal such as cobalt, nickel, manganese, mixtures thereof, among others, or a lithium composite oxide, part of whose lithium sites or transition metal sites is replaced with at least one member selected from the group consisting of cobalt, nickel, manganese, aluminum, boron, magnesium, iron, copper, or the like, or iron complex compounds. Specific examples of lithium composites for use as positive electrodes comprise at least one of lithium iron phosphate, LiFePO₄, LiNi₁₋ₓCoₓO₂, LiNi_{0.95-x}COₓAl_{0.05}O₂, LiCOₓNi_{y}Mn_{z}O₂, where x+y+z=1), lithium manganese spinel, LiMn₂O₄. Additional examples of suitable battery materials such as positive and negative electrode materials are described in patent application publication numbers JP 2007/258065A and US2007/0166609A1; hereby incorporated by reference

The separator for the lithium battery can comprise a microporous polymer film. Examples of polymers for forming films comprise at least one member selected from the group consisting of nylon, cellulose, nitrocellulose, polysulfone, polyacrylonitrile, polyvinylidene fluoride, polypropylene, polyethylene, polybutene, mixtures thereof, among others. Ceramic separators, based on silicates, aluminio-silicates, and their derivatives, among others, may also be used. Surfactants may be added to the separator or electrolyte to improve electrolyte wetting of the separator. Other components or compounds known to be useful in electrolytes or cells may be added.

In one embodiment, the battery is comprised of a carbonaceous lithium ion hosting negative electrode, a positive electrode, a separator, and a lithium-based electrolyte salt carried in an aprotic solvent, gel polymer or polymer matrix. Examples of carbonaceous negative electrodes include graphites and amorphous carbon (e.g., sometimes referred to as “hard carbon”).

Thus, additives can be used to improve the performance of cells using electrolytes of this invention provided the additives provide a drop in the reduction current of the electrolyte solution between the first and second CV scans or reduced self-discharge of the cells of this invention at elevated temperature storage. Additionally, a lower absolute reduction current on the second scan correlates well with lower irreversible capacity losses in the actual cells using the electrolyte.

The following examples are intended to illustrate various embodiments of the invention and do not limit the scope of the claims appended hereto.

### EXAMPLES

### Comparative Example 1

### CV of Li₂B₁₂F₁₂ in EC:DEC

In a dry box, a non aqueous electrolyte solution was prepared with 0.4 M Li₂B₁₂F₁₂ dissolved in a mixed solvent system consisting of ethylene carbonate (EC) and diethylcarbonate (DEC) in a 3 to 7 ratio by weight. Cyclic voltammetry (CV) was carried out in this electrolyte solution using a CHP Instruments 660a electrochemical workstation with a glassy carbon working (positive) electrode (Bioanalytical Systems, Inc.—MF2012) and lithium wire (FMC) counter (negative electrode) and lithium metal reference electrodes at a scan rate of 10 mV/s. Table 1 shows the result of this Comparative Example. The reduction current at 0.3 V increased in the second cycle, probably due to continuous reduction of the electrolyte solution. This indicates that the 0.4 M Li₂B₁₂F₁₂ in EC/DEC (3/7) electrolyte solution did not significantly passivate the glassy carbon electrode during the two CV scans at 10 mV/s.

### Comparative Example 2

### CV of Li₂B₁₂F₉H₃ in EC:DEC

Comparative Example 1 was repeated except Li₂B₁₂F₉H₃ was used instead of Li₂B₁₂F₁₂. Table 1 shows the result of this Comparative Example. The reduction current at 0.3 V increased in the second cycle, indicating that the 0.4 M Li₂B₁₂F₉H₃ in EC/DEC (3/7) electrolyte solution, did not significantly passivate the glassy carbon electrode.

### Example 3

### CV of Li₂B₁₂F₉H₃+LiPF₆ in EC:DEC

Comparative Example 2 was repeated, except that 1 wt % of LiPF₆ was added to the electrolyte solution. Table 1 shows the result of this Example. The reduction current in the second scan was lower compared to the first scan. Moreover, the reduction current was lower than the reduction current obtained in 0.4 M Li₂B₁₂F₉H₃/EC/DEC solution without any additives (Comparative Example 2). Therefore, LiPF₆ as an additive to the electrolyte will provide lower irreversible capacity and higher discharge capacities.

### Example 4

### CV of Li₂B₁₂F₉H₃+LiBF₄ in EC:DEC

Comparative Example 2 was repeated, except that 3 wt % LiBF₄ was added to the electrolyte solution. Table 1 shows the result of this Example. The reduction current was lower in the second cycle, indicating that the Li₂B₁₂F₉H₃+LiBF₄ in EC/DEC (3/7) electrolyte solution passivated the glassy carbon electrode. Therefore, LiBF₄ as an additive to the electrolyte provides lower irreversible capacity and higher discharge capacities.

### Example 5

### CV of Li₂B₁₂F₉H₃+VC in EC:DEC

Comparative Example 2 was repeated, except that 3 wt % VC was added to the electrolyte solution. Table 1 shows the result of this example. The reduction current decreased in the second cycle at 0.3V, indicating passivation after the first cycle.

### Example 6

### CV of Li₂B₁₂F₉H₃+VEC in EC:DEC

Comparative Example 2 was repeated, except that 5 wt % VEC was added to the electrolyte solution. Table 1 shows the result of this Example. The reduction current decreased in the second cycle at 0.3 V, indicating passivation after the first cycle.

### Example 7

### CV of Li₂B₁₂F₉H₃+LiBOB in EC:DEC

Comparative Example 2 was repeated, except that 5 wt % LiBOB was added to the electrolyte solution. Table 1 shows the result of this experiment. The reduction current is lower in the second cycle at 0.3 V, indicating that the Li₂B₁₂F₉H₃+LiBOB in EC/DEC (3/7) electrolyte solution passivates the glassy carbon electrode better than Li₂B₁₂F₉H₃ alone.

### Example 8

### Prepassivation Using LiPF₆ Solution

A glassy carbon working electrode was passivated by performing cyclic voltammetry experiments (3 scans) at 10 mWs in the 4-0.2 V potential region in an EC/DEC (3/7) solution containing 1.0 M LiPF₆, using a lithium wire counter and reference electrodes as described in the previous examples. The prepassivated working electrode was then washed to remove any adsorbed electrolyte and transferred to a cell containing 0.4 M Li₂B₁₂F₁₂ in EC/DEC (3/7), and no passivation additive. CV was repeated as above in the 4-0.2 V potential region at 10 mV/s to confirm that the prepassivation performed in LiPF₆ solution was stable. The prepassivation layer of the electrode was stable in the electrolyte having no additive, and the reduction current decreased with respect to that of the original scan at 0.3 V. The results are shown in Table 1.

TABLE 1

| | Current μA @ 0.3 V | | | |
|---|---|---|---|---|
| Example | 1SCAN | 2SCAN | RATIO | RATIO × 1SCAN |
| Comparative 2 | 13 | 17 | 1.31 | 22.23 |
| Comparative 1 | 12 | 16 | 1.33 | 21.33 |
| 6 | 33 | 29 | 0.88 | 25.48 |
| 5 | 26 | 21 | 0.81 | 16.96 |
| 4 | 12 | 10 | 0.83 | 8.33 |
| 7 | 7 | 6 | 0.86 | 5.14 |
| 3 | 5 | 3 | 0.60 | 1.80 |
| 8 | 5.5 | 2.5 | 0.45 | 1.13 |

Examples 1-7 summarized in Table 1 show the impact of inorganic, organic and absence of additives on the reduction currents, determined by cyclic voltammetry of electrolyte solutions vs Li/Li⁺. Reducible inorganic salt additives result in a significant drop in reduction current between the first and second CV scans and the lowest absolute reduction currents. The electrolytes with the organic additives added showed a decrease in reduction current indicating passivation. The comparative examples with no additives had an increase in reduction current in the second cycle typically predicting poor cell performance.

Example 8 showed that a stable prepassivation layer could be formed, and that the electrode with the stable prepassivation layer could provide benefits to a cell having an electrolyte without an additive.

### Example 9

### Preparation and Testing of Cell

### GDR(−)//0.4M Li₂B₁₂F₉H₃ and 1 wt % LiPF₆ in 3:7 EC:DEC//GEN2(+)

### Preparation of Electrolyte

A non-aqueous solvent was prepared by mixing ethylene carbonate (EC) and diethyl carbonate (DEC) in a weight ratio of 3:7. Li₂B₁₂F₉H₃ was dissolved to a concentration of 0.4M to prepare the electrolyte. Subsequently an additive LiPF₆ in 1 wt % was added to the electrolytic solution.

### Preparation of Lithium Secondary Battery and Measurement of Battery Characteristics

A coin type battery cell (diameter 20 mm, thickness 3.2 mm) consisting of a positive electrode, negative electrode, separator and electrolyte was prepared at room temperature. The positive electrode, referred to as GEN2, consisted of LiCO_{0.8}Ni_{0.15}Al_{0.05}O₂ (cathode active material) 84% by weight, carbon black (conducting agent) 4% by weight, SFG-6 graphite (conducting agent) 4% by weight, and polyvinylidene fluoride (binder) 8% by weight on an aluminum foil current collector. The negative electrode, referred to as GDR, consisted of MAG-10 graphite (anode active material) 92% by weight, and polyvinylidene fluoride (binder) 8% by weight on a copper foil current collector. Celgard™ 3501 (available from Celgard Inc.), a microporous polypropylene film, was used as the separator.

The cell was charged by a constant current of 0.1 mA (C/20) to a voltage of 4.1V followed by a discharge current of 0.1 mA (C/20) to 3V. This cycling was repeated a second time. The cell was then charged by a constant current of 0.7 mA (C/3) to a voltage of 4.1V followed by a discharge current of 0.7 mA (C/3) to 3V.

Table 2 summarizes the coulomb efficiency of the cell during the 3 initial charge/discharge formation cycles. The initial coulomb efficiency (charge out/charge in), which directly relates to the irreversible capacity loss at the first charging, was 81%. Upon subsequent cycling, the coulomb efficiency for the second cycle was 100% indicating that an adequate passivation layer was formed. Upon subsequent cycling at a higher C/3 rate (0.7 mA) the coulomb efficiency was 90% indicating that this cell had good rate performance. Discharge Capacity Retention is calculated by dividing the C/3 discharge capacity by the C/20 discharge capacity, and was 88% for this additive in the cell. In most cases, the higher the Discharge Capacity Retention the better the cell performance.

### Comparative Example 10

### Preparation and Testing of Cell

### GDR(−)//0.4M Li₂B₁₂F₉H₃ 3:7 EC:DEC//GEN2(+)

The same procedure was followed as in Example 9; however, no LiPF₆ was added. The initial coulomb efficiency, which directly relates to the irreversible capacity loss at the first charging, was 76%. Upon subsequent cycling, the coulomb efficiency for the second cycle was 97%, a small decrease from the previous example. The coulomb efficiency from the third higher rate C/3 cycle was 90% comparable to the previous example. The Discharge Capacity Retention was 87%.

### Example 11

### Preparation and Testing of Cell

### GDR(−)/0.4M Li₂B₁₂F₉H₃ and 3 wt % LiBF₄ in 3:7 EC:DEC//GEN2(+)

The same procedure was followed as in Example 9, however, a different additive LiBF₄ was added in 3% by weight to the electrolyte solution. The initial coulomb efficiency, which directly relates to the irreversible capacity loss at the first charging, was 81%. Upon subsequent cycling, the coulomb efficiency for the second cycle was 98%. The coulomb efficiency from the third higher rate C/3 cycle was 94% indicating an improved performance benefit of this additive. The Discharge Capacity Retention was 90%.

### Example 12

### Preparation and Testing of Cell

### GDR(−)//0.4M Li₂B₁₂F₉H₃ and 5 wt % VEC in 3:7 EC:DEC//GEN2(+)

The same procedure was followed as in Example 9; however, a different additive 5% by weight VEC was added to the electrolyte solution. The initial coulomb efficiency, which directly relates to the irreversible capacity loss at the first charging, was 67% indicating a significant capacity loss for the cell. Upon subsequent cycling, the coulomb efficiency for the second cycle was 95% indicating that the passivation layer was still forming on the second cycle. The coulomb efficiency from the third higher rate cycle was 72% indicating a loss in rate performance for this additive. The Discharge Capacity Retention was 57%, indicating a loss in performance.

### Example 13

### Preparation and Testing of Cell

### GDR(−)/0.4M Li₂B₁₂F₉H₃ and 3 wt % LiBOB in 3:7 EC:DEC//GEN2(+)

The same procedure was followed as in Example 9; however, a different additive lithium bis-oxalatoborate, or LiBOB, was added in 3% by weight to the electrolyte. The initial coulomb efficiency, which directly relates to the irreversible capacity loss at the first charging, was 79%. Upon subsequent cycling, the coulomb efficiency for the second cycle was 100% indicating that an adequate passivation layer was formed. Upon subsequent cycling at a higher C/3 rate, the coulomb efficiency was 87%. The Discharge Capacity Retention was 79%.

### Example 14

### Preparation and Testing of Cell

### GDR(−)//0.4M Li2B12F9H3 and 1 wt % VC in 3:7 EC:DEC//GEN2(+)

The same procedure was followed as in Example 9, however, a different additive VC was added in 1% by weight to the electrolyte solution. The initial coulomb efficiency, which directly relates to the irreversible capacity loss at the first charging, was 69% indicating a significant capacity loss for the cell. Upon subsequent cycling, the coulomb efficiency for the second cycle was 92% indicating that the passivation layer was still forming on the second cycle. The coulomb efficiency from the third higher rate cycle was 86%. The Discharge Capacity Retention was 80%.

The data from Examples 9-14 is summarized in Table 2.

TABLE 2

| | | | 3^{rd} Cycle | |
|---|---|---|---|---|
| | 1^{st} | 2^{nd} | Coulomb | |
| Additive | Cycle Coulomb | Cycle Coulomb | Efficiency | Discharge |
| Example | Efficiency C/20 | Efficiency C/20 | C/3 | Retention |
| 1 wt % LiPF₆ | 81% | 100% | 90% | 88% |
| Ex. 11 | | | | |
| No Additive | 76% | 97% | 90% | 87% |
| Comp Ex. 12 | | | | |
| 3 wt % LiBF₄ | 81% | 98% | 94% | 90% |
| Ex. 13 | | | | |
| 5 wt % VEC | 67% | 95% | 72% | 57% |
| Comp Ex. 14 | | | | |
| 3 wt % LiBOB | 79% | 100% | 87% | 79% |
| Ex. 15 | | | | |
| 1 wt % VC | 69% | 92% | 86% | 80% |
| Ex. 16 | | | | |

Table 2 shows that the coulombic efficiency data from cells correlates well with the CV data in Examples 1-7. The data shows that inorganic additives that were tested provided decreased irreversible capacity loss.

### Example 15

### GDR(−)//0.4M Li₂B₁₂F₉H₃ and 1 wt % LiPF₆ in 3:7 EC:DEC//GEN2(+)

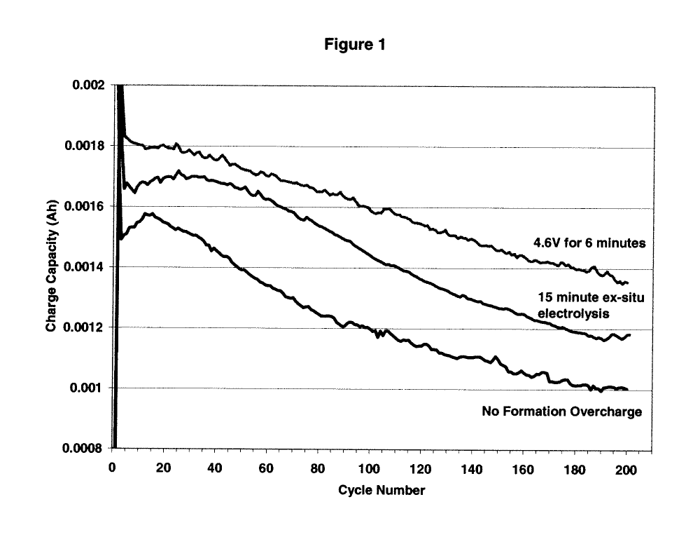

The same procedure was followed as in Example 9; however, in the measurement of battery characteristics the formation cycle consisted of a constant current charge of 0.1 mA (C/20) to a voltage of 4.1V followed by a discharge current of 0.1 mA (C/20) to 3V. Subsequently the cell was charged and discharged at current of 0.7 mA (C/3) between 4.1V and 3V for 102 cycles to investigate the capacity retention. FIG. 1 shows the cell capacity (Ah) on the ordinate and the charge/discharge cycle number on the abscissa. The cell capacity maintains a relatively constant level after the initial rise in capacity.

### Comparative Example 16

### GDR(−)//0.4M Li2B12F9H3 in 3:7 EC:DEC//GEN2(+)

The same procedure was followed as in Example 15, however, no LiPF₆ was added. FIG. 1 shows that after the initial rise in capacity, as was observed in the previous example, the capacity retention decreases more during each successive cycle. This shows that the cycle life of this cell with an additive is better than the cell without an additive.

### Comparative Example 17

### HC(−)//0.4M Li₂B₁₂F₁₂ in 3:7 EC:EMC//NMC(+)

### Preparation of Electrolyte

A non-aqueous solvent was prepared by mixing ethylene carbonate (EC) and ethyl methyl carbonate (EMC) in a weight ratio of 3:7. Li₂B₁₂F₁₂ was dissolved to a concentration of 0.4M to prepare the electrolyte.

### Preparation of Lithium Secondary Battery and Measurement of Battery Characteristics

A coin type battery cell (diameter 20 mm, thickness 3.2 mm) consisting of a positive electrode, negative electrode, separator and electrolyte was prepared at room temperature. The positive electrode, referred to as NMC, consisted of LiNi_{0.3}Mn_{0.3}Co_{0.3}O₂ (cathode active material) 88% by weight, conducting agent 6% by weight, and polyvinylidene fluoride (binder) 6% by weight on an aluminum foil current collector. The negative electrode, referred to as HC, consisted of hard carbon (anode active material) 90% by weight, and polyvinylidene fluoride (binder) 10% by weight on a copper foil current collector. Celgard™ 3501 (available from Celgard Inc.), a microporous polypropylene film, was used as the separator.

The cell was initially charged by a constant current of 0.1 mA (˜C/12) to a voltage of 4.2V followed by a discharge current of 0.1 mA (˜C/12) to 3V. The cell was then charged by a constant current of 2 mA (2.5 C) to a voltage of 4.2V followed by a constant voltage hold at 4.2V for 2 days and 13 hours in an oven at 60° C. The leakage current (in μA) was measured during this voltage holding period. The cell was then discharged to 3V. The cell was cycled 3 times at 1 mA (1.25 C) from 3 to 4.1V in order to measure the charge and discharge capacity. The capacity retention was calculated by dividing the remaining charge capacity in the cell from the second charge cycle (at room temperature) after the hold by the charge capacity (3-4.1 V) before the holding step. The area specific impedance (ASI) of the cell was measured at room temperature. The charge ASI was subsequently measured by charging for 10 minutes at 1 mA (1.25 C) then resting for 30 seconds and continuing this procedure until a voltage of 4.1V was reached. The discharge ASI was measure by discharging for 10 minutes at 1 mA (1.25 C) then resting for 30 seconds and continuing until the voltage was at 3V. The ASI was computed as the ratio of the V₂−V₁/I₂−I₁*1.6 cm², where V₁ and I₁ are the voltage and current of the cell after 10 minutes charging/discharging and V₂ and I₂ are the voltage and current of the cell after the 30 second resting period. The area of an electrode in the coin cell is 1.6 cm². A post-mortem analysis of the electrolyte was done to determine by ¹⁹F NMR the B₁₂F₁₁H²⁻ (triplet {5:5:1} −265 ppm) to B₁₂F₁₂²⁻ (singlet −270 ppm) ratio.

Table 3 summarizes the findings for this cell as well as the other comparative examples below. The first column is the electrolyte composition with and without additives. The leakage current peak value was 33 μA which was the highest value indicating electrochemical processes in the cell at 4.2V and 60° C. The ASI after the high voltage high temperature hold was 211 Ω-cm² which indicates a non-operational cell. The charge capacity retention after the hold was 26% which also indicates a non-operational cell. The F12 reduction of B₁₂F₁₂²⁻ was 23% to B₁₂F₁₁H²⁻ indicating the electrolyte was not electrochemically stable at 4.2V and 60° C.

### Example 18

### HC(−)//0.3M Li₂B₁₂F₁₂ 0.2M LiBF₄ in 3:7 EC:EMC//NMC(+)

The same procedure was followed as in Example 17, in addition the additive LiBF₄ was added in 0.2M concentration to the electrolyte solution. The leakage current peak value was 15 μA which was the second highest value indicating electrochemical processes in the cell at 4.2V and 60° C. The ASI after the high voltage high temperature hold was 36 Ω-cm² which indicates a low resistance in the cell. The charge capacity retention after the hold was 74% which also indicates a that the cell remained functional after the hold step. The F12 reduction of B₁₂F₁₂²⁻ was 17% to B₁₂F₁₁H²⁻ indicating the electrolyte was not electrochemically stable at 4.2V and 60° C.

### Example 19

### HC(−)//0.3M Li₂B₁₂F₁₂ 0.05M LiBOB in 3:7 EC:EMC//NMC(+)

The same procedure was followed as in Example 17, in addition the additive LiBOB was added in 0.05M concentration to the electrolyte solution. The leakage current peak value was 5 μA which was the second lowest value indicating an absence of electrochemical processes in the cell at 4.2V and 60° C. The ASI after the high voltage high temperature hold was 71 Ω-cm² which indicates a highly resistive cell. The charge capacity retention after the hold was 67% which also indicates that the cell remained functional after the hold step but with a lowered capacity. The F12 reduction of B₁₂F₁₂²⁻ was not detected (ND) to B₁₂F₁₁H², indicating the electrolyte was electrochemically stable at 4.2V and 60° C.

### Example 20

### HC(−)//0.3M Li₂B₁₂F₁₂ 0.2M LiBF₄ 0.05M LiBOB in 3:7 EC:EMC//NMC(+)

The same procedure was followed as in Example 17, in addition the additives LiBF₄ was added in 0.2M concentration and LiBOB was added in 0.05M to the electrolyte solution. The leakage current peak value was 4 μA which was the lowest value indicating an absence electrochemical processes in the cell at 4.2V and 60° C. The ASI after the high voltage high temperature hold was 39 Ω-cm² which indicates a low resistance in the cell. The charge capacity retention after the hold was 77% which also indicates that the cell remained functional after the hold step. The F12 reduction of B₁₂F₁₂²⁻ was not detected (ND) to B₁₂F₁₁H²⁻ indicating the electrolyte was electrochemically stable at 4.2V and 60° C.

The data from Examples 17-20 is summarized in Table 3.

TABLE 3

| | Leakage | | | |
|---|---|---|---|---|
| Electrolyte | Current | ASI | Charge Capacity | F12 Reduction |
| (3:7 EC:EMC) | (μA) | (Ω-cm²) | Retention (%) | (%) |
| Example 1. | 33 | 211 | 26 | 23 |
| 0.4M Li₂B₁₂F₁₂ | | | | |
| Example 2. | 15 | 36 | 74 | 17 |
| 0.3M Li₂B₁₂F₁₂ | | | | |
| 0.2M LiBF₄ | | | | |
| Example 3. | 5 | 71 | 67 | ND |
| 0.3M Li₂B₁₂F₁₂ | | | | |
| 0.05M LiBOB | | | | |
| Example 4. | 4 | 39 | 77 | ND |
| 0.3M Li₂B₁₂F₁₂ | | | | |
| 0.2M LiBF₄ | | | | |
| 0.05M LiBOB | | | | |

Table 3 shows that the addition of both LiBF₄ and LiBOB to the base Li₂B₁₂F₁₂ electrolyte composition decreases the leakage current at the 4.2V hold (60° C.) and improves the ASI and charge capacity retention after the hold and prevents F12 reduction.

The present invention is not to be limited in scope by the specific aspects or embodiments disclosed in the examples which are intended as illustrations of a few aspects of the invention and any embodiments that are functionally equivalent are within the scope of this invention. Various modifications of the invention in addition to those shown and described herein will become apparent to those skilled in the art and are intended to fall within the scope of the appended claims.

1. An electrolyte comprising a salt of the formula:
LiₐQ
where Q is a borate cluster anion or heteroborate cluster anion, and a is 1 or 2, at least one organic aprotic carrier, and at least two additives wherein at least one of said additives comprises an inorganic compound.

2. The electrolyte of claim 1 wherein said inorganic additive comprises at least one member selected from the group consisting of boron, carbon, nitrogen, phosphorous, arsenic, antimony, oxygen, sulfur, fluorine, and chlorine.

3. The electrolyte of claim 1 wherein said inorganic additive comprises at least one member selected from the group consisting of lithium hexafluorophosphate (LiPF₆), lithium bis-oxalatoborate (LiBOB), lithium perchlorate (LiClO₄), lithium hexafluoroarsenate (LiAsF₆), lithium trifluoromethanesulfonate (LiCF₃SO₃), lithium trifluoromethanesulfonimide (Li(CF₃SO₂)₂N, lithium tetrafluoroborate (LiBF₄), lithium tetrachloroaluminate (LiClO₄), lithium hexafluoroantimonate (LiSbF₆), CO₂, and water.

4. The electrolyte of claim 2 wherein said inorganic additive comprises at least one chelato borate salt.

5. The electrolyte of claim 2 wherein one of said additives comprises an organic compound and said additive comprises at least one member selected from the group consisting of carbonates, chloroethylene carbonate, vinylene carbonate, vinylethylenecarbonate, sulfites, ethylene sulfite, propane sulfone, propylene sulfite, butyrolactones, phenylethylene carbonate, phenylvinylene carbonate, catechol carbonate, vinyl acetate, vinylethylene carbonate, dimethyl sulfite, fluoroethylene carbonate, trifluoropropylene carbonate, bromo gamma-butyrolactone, and fluoro gamma-butyrolactone.

6. The electrolyte of claim 2 wherein said inorganic comprises LiBF4 and said additive further comprise another member selected from the group consisting of inorganic and organic compounds.

7. The electrolyte of claim 6 wherein said another member comprises LiBOB.

8. The electrolyte of claim 6 wherein said another member comprises an organic compound.

9. The electrolyte of claim 8 wherein said organic compound comprises VC.

10. The electrolyte of claim 1 wherein said LiaQ comprises Li₂B₁₂FₓZ₁₂₋ₓ wherein x Z represents H, Cl, Br and x is at least 8 and less than or equal to 12.

11. A cell comprising a positive electrode, a negative electrode and an electrolyte comprising at least one organic aprotic compound, Li₂B₁₂FₓZ₁₂₋ₓ wherein x Z represents H, Cl, Br and x is at least 8 and less than or equal to 12 and at least two additives wherein at least one of said additives comprises an inorganic compound.

12. The cell of claim 11 wherein said inorganic additive comprises at least one member selected from the group consisting of selected from the group consisting of lithium hexafluorophosphate (LiPF₆), lithium bis-oxalatoborate (LiBOB), or other chelatoborate salt, lithium perchlorate (LiClO₄), lithium hexafluoroarsenate (LiAsF₆), lithium trifluoromethanesulfonate (LiCF₃SO₃), lithium trifluoromethanesulfonimide (Li(CF₃SO₂)₂N, lithium tetrafluoroborate (LiBF₄), lithium tetrachloroaluminate (LiClO₄), and lithium hexafluoroantimonate (LiSbF₆).

13. The cell of claim 11 wherein said additive comprises at least one organic compound wherein said additive is selected from the group consisting of carbonates, chloroethylene carbonate, vinylene carbonate, vinylethylenecarbonate, sulfates, ethylene sulfite, propane sulfone, propylene sulfite, butyrolactones, phenylethylene carbonate, phenylvinylene carbonate, catechol carbonate, vinyl acetate, vinylethylene carbonate, dimethyl sulfite, fluoroethylene carbonate, trifluoropropylene carbonate, bromo gamma-butyrolactone, and fluoro gamma-butyrolactone.

14. The cell of claim 12 wherein said additive comprises lithium bis-oxalatoborate (LiBOB) and lithium tetrafluoroborate (LiBF₄).

15. The cell of claim 12 wherein said inorganic compound comprises LiBF₄ and said additive further comprises at least one organic compound.

16. The cell of claim 15 wherein said organic compound comprises VC.

17. The cell of claim 12 wherein said negative electrode comprises a carbonaceous material.

18. The cell of claim 12 wherein said negative electrode comprises lithium metal or its alloys with other metals

19. The cell of claim 12 wherein said positive electrode comprises a lithium composite oxide.

20. The cell of claim 19 wherein said positive electrode comprises lithium manganese spinel.

21. The cell of claim 12 wherein said cell comprises a secondary battery.
